(19) United States
(12) Patent Application Publication
(10) Pub. No.: US 2026/0171717 A1
(43) Pub. Date: Jun. 18, 2026

(54) Lever-Type Connector Assembly for Automated Assembly

(71) Applicant: TE Connectivity India Private Limited, Bangalore (IN)

(72) Inventors: Jigar TANK, Bangalore (IN); Vishwanath ATTAD, Bangalore (IN); Amith Manjunath B, Bangalore (IN); Gopi KT, Bangalore (IN)

(73) Assignee: TE Connectivity India Private Limited, Bangalore (IN)

(21) Appl. No.: 19/411,439

(22) Filed: Dec. 8, 2025

(30) Foreign Application Priority Data
Dec. 12, 2024 (EP) 24219267.2

(51) Int. Cl. H01R 13/629

(52) U.S. Cl. CPC H01R 13/62938; H01R 13/62955

(57) ABSTRACT

A plug connector for being mated with a mating connector, to the mating connector, the connector assembly, and to a method of mating a connector assembly. A plug connector for being mated with a mating connector comprises a rotatable lever, which is operable to be rotated between an unlocked position and a locked position; and a first housing comprising a pivot bearing for rotatably supporting the rotatable lever. The lever comprises an actuating element, which is engageable with a driving element arranged at the mating connector, the actuating element being operable to un-mate the plug connector from the mating connector by rotating the lever from the locked position into the unlocked position, wherein the rotatable lever has latching means, which are operable to lock the plug connector at a corresponding locking element of the mating connector without rotating the lever, when the lever is in the locking position.

### CROSS-REFERENCE TO RELATED APPLICATION

This application claims the benefit of European Patent Application No. 24219267.2 filed on Dec. 12, 2024 in the European Patent Office, which is hereby incorporated by reference in its entirety.

### BACKGROUND OF THE INVENTION

The present disclosure relates to lever-type connector assemblies. In particular, the present disclosure relates to a plug connector for being mated with a mating connector, to the mating connector, the connector assembly, and to a method of mating a connector assembly.

Connector assemblies having a lever are known in the industry. Generally, an electrical connector assembly of this type comprises a plug connector that is mateable with a pin header, which has a shroud surrounding an array of printed circuit board pins.

A rack and pinion and a lever are, for instance, used to supply a mechanical advantage when the two electrical connectors are mated or unmated.

The rack is located on the plug connector, which typically would include terminals attached to wires. For instance, teeth forming a pinion are located on the lever so that the rack and pinion teeth intermesh as the lever is rotated about a pivot pin. Thus, rotation of the lever mates or unmates two electrical connectors.

However, for an automated connector assembly, the lever-operated connectors are disadvantageous because an automatic assembly of a connector involving the angular or swiveling movement of a lever is complex and does not meet the automated assembly requirements.

In the automotive application field, the presence of a lever is mandatory in order to reduce the mating force of bigger connectors when reattaching them during manual servicing. Thus, the connector assembly needs a lever for later servicing but should not be reliant on the function of the lever during the automated mating, i.e. during the fabrication and assembly process.

Consequently, there is a need for a lever-type connector assembly which is designed to allow an automatic assembly, but still fulfills the requirements for manual mating and unmating.

### SUMMARY OF THE INVENTION

This object is solved by the subject matter of the independent claims. Advantageous examples of the present disclosure are the subject matter of several dependent claims.

The present disclosure is based on the idea to design the lever in a manner that it has two functionalities: Firstly, the lever serves as an actuator to assist mating and unmating of the plug connector and mating connector by rotating between an unlocked and a locked position. Secondly, the lever also has, in its locked position, the additional functionality of forming a latching means for securing the plug connector and the mating connector in the connected state. IN other words, a lever-actuated plug and a header that can be mated without rotation of the lever, when the lever is in its end lock position. Therefore, the lever integrates latch functionality.

The present disclosure provides a connector that comprises a pivoted lever, which locks said connector to a mating connector in multiple ways without rotating said lever. For instance, in one embodiment, the plug may have a lever, which comprises a pair of resilient lever arms and cam slots, and the header has pins, which engage the cam slots. The end lock section of the cam slot is designed as a latch that overcomes the pins. The rim of the end lock section provides a ramped surface that engages a ramped surface on the pin. During mating with the lever in its end lock position, the ramped surface of the pin pushes the rim of the lever's end lock section over said pin. In a second embodiment, the plug may have a lever, which comprises gears, and the header has resilient gear racks. The gear rack is designed as a latch that overcomes the lever's end lock section and snaps directly onto the lever's gears. The end lock section of the lever provides a ramped surface that engages a ramped surface on the end of the gear rack. During mating with the lever in its end lock position, the ramped surface of the lever pushes the gear rack over the end lock section of the lever and the teeth of the gear rack snap onto the teeth of the lever's gear.

According to an aspect of the present disclosure, a plug connector for being mated with a mating connector is provided, the plug connector comprising a rotatable lever, which is operable to be rotated between an unlocked position and a locked position, and a first housing comprising a pivot bearing for rotatably supporting the rotatable lever. The lever comprises an actuating element, which is engageable with a driving element arranged at the mating connector, the actuating element being operable to un-mate the plug connector from the mating connector by rotating the lever from the locked position into the unlocked position. Further, the rotatable lever has latching means, which are operable to lock the plug connector at a corresponding locking element of the mating connector without rotating the lever, when the lever is in the locking position.

Advantageously, the connector is designed in a such a way that it allows mating with lever in the end lock position. Additionally, the lever can be used for manual mating and un-mating of the connector assembly. Therefore, during the manufacturing process, the lever operated connector can be assembled without the help of lever in automatic assembly, while mating and un-mating can still be done with the help of lever, thus fulfilling respective requirements for manual assembly and disassembly. In particular, a lever is mandatory for manual servicing in order to reduce the mating force of bigger connectors.

Advantageously, existing connectors can be modified to meet automated assembly requirements with only few design and tool changes. The concept according to the present disclosure can be implemented for both cam lever and gear lever designed connectors.

According to an advantageous example, the lever may comprise two resilient lever arms, the lever arms partly encompassing the first housing and being interconnected by a bridge, which is accessible for actuating the lever, and wherein the pivot bearing comprises two shafts, each supporting one lever arm. With this construction, a particularly symmetric and uniform force transmission and mechanical stability can be achieved.

According to an advantageous example, the lever may comprise at least one cam slot forming the actuating element and being engageable with a corresponding cam follower pin arranged at the mating connector. This design may be adapted in a particularly easy and cost effective manner to the improved automation friendly concept by just replacing the lever. In order to facilitate the automated assembly of the plug connector the latching means may comprise a slanted peripheral region, which allows to form a snap fit connection between the cam slot and the cam follower pin when mating the plug connector and the mating connector. The belonging cam follower pin may have a corresponding slanted region to reduce the mating forces that have to be applied for the assembly.

Alternatively, the actuating element may comprise a gear element, which is engageable with a corresponding gear rack arranged at the mating connector. Compared to cam actuated connectors, the interaction between a gear at the lever and a gear rack at the mating connector's housing allows a uniform transmission of much higher forces, e.g. for larger connectors having more electrical conductors to be mated.

According to an advantageous example, the latching means comprise a slanted peripheral region, which allows to form a snap fit connection between the gear element and the gear rack when mating the plug connector and the mating connector. Thus, the gear element and the gear rack may slide past each other until the gear element and the gear rack engage to form a locking connection. In contrast to the actuated connectors, the gear rack section at the mating connector's housing may form a resilient (i.e. deflectable) arm that is deflected when the lever slides by during the mating.

According to another aspect of the present disclosure, a mating connector is provided for being mated with a plug connector according to the present disclosure. The mating connector comprises a second housing comprising a driving element which is engageable with the actuating element arranged at the rotatable lever of the plug connector, wherein the driving element is operable to un-mate the plug connector from the mating connector by rotating the lever from a locked position into an unlocked position. The driving element is further formed as a locking element operable to lock the mating connector at the plug connector without rotating the lever, when the lever is in the locking position.

If the connector assembly is based on a cam actuated design, the locking element at the mating connector may comprise at least one cam follower pin, the cam follower pin having a ramped upper region, which allows the lever to slide over the cam follower pin during the mating operation. It should be noted, however, that the cam follower pin may also be without a ramped upper region, thus relying only on the slanting entry chamfers of the lever. Providing slanted regions on both parts facilitates the mating process.

According to a further example, the locking element comprises at least one cam follower pin, the cam follower pin being operable to deflect a snap hook so that the snap hook can slide over the cam follower pin during the mating operation.

As mentioned above, the locking element may advantageously comprise at least one deflectable gear rack, which allows a gear element of the lever to slide into an engagement with the gear rack during the mating operation.

In order to further facilitate the mating process, the deflectable gear rack may have a chamfered end section to allow the gear element of the lever to slide into engagement with the gear rack during the mating operation.

According to another aspect of the present disclosure, the present disclosure provides a connector assembly comprising a plug connector and a mating connector according to the present disclosure.

According to still another aspect of the present disclosure, a method of mating a connector assembly is provided, the method comprising the following steps: aligning the plug connector and the mating connector, so that they can be mated in a mating direction; moving the plug connector with respect to the mating connector along the mating direction, until a final mated position is reached; wherein, during the moving step, the lever is in the locking position and is slid along the mating direction into a latching position, in which the plug connector is locked at a corresponding locking element of the mating connector without rotating the lever.

Advantageously, this method can be performed in a fully automated manner and does not involve any complex angular rotation movement of the lever. This significantly reduces the assembly costs and enhances the reliability. For a later servicing, the connection between the plug connector and the mating connector (also referred to as a header) can be loosened by rotating the lever from the end lock position into its unlocked position. Furthermore, the plug connector can be re-attached manually by aligning the two connectors with respect to each other and then manually pivoting the lever from the unlocked position into the end lock position.

According to a first example, the lever may be deflectable and is slid over a cam follower pin arranged at the mating connector, so that the cam follower pin engages with a cam slot arranged at the lever. This is a comparatively simple design suitable for connectors involving lower insertion forces.

According to a second example, the mating connector may comprise at least one deflectable gear rack, which is deflected in a direction across to the mating direction to allow a gear element of the lever to slide into an engagement with the gear rack. This design is also suitable for larger connector assemblies involving high insertion forces due to a large number of electrical conductors which have to be connected.

According to a further example, the connector comprises a locking slider, which has a snap hook deflectable in a direction across to the mating direction to be slid over a over a cam follower pin arranged at the mating connector, so that the cam follower pin engages with a cam slot arranged at the locking slider. The slider further comprises a gear rack, which can be actuated by a gear element at the lever. Thus, the slider transforms the swiveling motion of the lever into a uniform translational movement for manually mating and unmating the connector and mating connector. When automatically assembling the connector and mating connector, the snap hook can easily be deflected, thus bypassing the locking slider's and the lever's movements.

As mentioned above, the lever in the final mounted position (i.e. the end lock position) can be rotated to perform an un-mating of the plug connector and the mating connector. Thus, the requirements regarding manual serviceability are met. Also, the mating may afterwards be performed manually by rotating the lever back into the end lock position.

### BRIEF DESCRIPTION OF THE DRAWINGS

The accompanying drawings are incorporated into and form a part of the specification to illustrate several examples of the present disclosure. These drawings together with the description serve to explain the principles of the disclosure. The drawings are merely for the purpose of illustrating the preferred and alternative examples of how the disclosure can be made and used, and are not to be construed as limiting the disclosure to only the illustrated and described examples. Furthermore, several aspects of the examples may form—individually or in different combinations—solutions according to the present disclosure. Further features and advantages will become apparent from the following more particular description of the various examples of the disclosure, as illustrated in the accompanying drawings, in which like references refer to like elements, and wherein:

FIG. 1 shows schematically a perspective view of a plug connector forming a receptacle;

FIG. 2 shows schematically a perspective view of a mating connector forming a tab;

FIG. 3 shows a schematic perspective view of an assembly comprising the receptacle and tab of FIGS. 1 and 2;

FIG. 4 shows a detail of the tab;

FIG. 5 shows a schematic perspective view of the lever;

FIG. 6 shows a schematic illustration of the mating process;

FIG. 7 shows a further schematic perspective view of the mated assembly of FIG. 3;

FIG. 8 shows a schematic illustration of the un-mating process;

FIG. 9 shows schematic perspective representation of a lever and a housing of the mating connector according to a second example;

FIG. 10 schematically illustrates the mating process of the assembly according to the second example;

FIG. 11 shows a schematic perspective view of the mated assembly according to the second example;

FIG. 12 shows a detail of FIG. 11;

FIG. 13 shows a schematic illustration of the un-mating process of the assembly of FIG. 11;

FIG. 14 schematically illustrates the mating process of an assembly according to a third example;

FIG. 15 shows a schematic perspective view of the mated assembly according to the third example;

FIG. 16 shows a schematic perspective view of the slider provided according to the third example;

FIG. 17 shows a detail of FIG. 16;

FIG. 18 schematically illustrates in a partially cut view the mating process of the assembly according to the third example;

FIG. 19 shows a detail of FIG. 18;

FIG. 20 shows a schematic illustration of the un-mating process of the assembly of FIG. 15.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

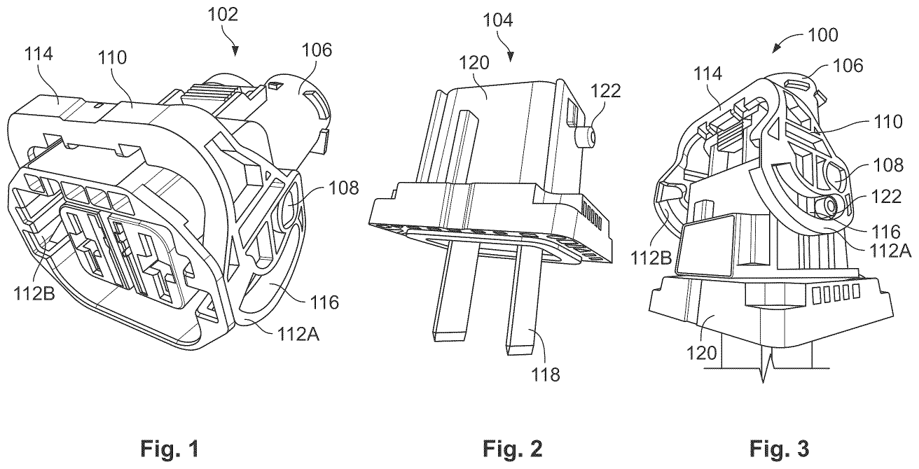

FIGS. 1 to 8 show schematic perspective representations illustrating a connector assembly 100 of a first example.

Referring to FIG. 1, a plug connector 102 is shown, which is designed for being mated with a mating connector 104, which is shown in FIG. 2. The plug connector 102 is for instance a receptacle and the belonging mating connector 104 is a tab connector. The plug connector 102 comprises a first housing 106, which has two protruding posts 108, which form a pivot bearing for rotatably supporting a rotatable lever 110.

The lever 110 has an essentially u-shaped cross-section comprising two flexible arms 112A, 112B and a bridge 114 interconnecting the arms 112A, 112B. The lever 110 may be rotated around the pivot bearing 108 by touching it at the bridge 114. As will be apparent from further contemplating FIGS. 2 and 3, each of the arms 112A comprises a cam slot 116.

FIG. 2 perspectively illustrates the mating connector 104, which is for instance connected with its tabs 118 to a battery. Of course, the tabs 118 are only exemplary electric connections of the mating connector 104.

When mating the mating connector in a mating direction into the plug connector, the second housing 120 is partly encompassed by the first housing 106, wherein two cam follower pins 122 extend through the first housing 106 and may engage with the cam slot 116 in the fully assembled state of the connector assembly 100.

FIG. 3 illustrates the connector assembly 100 in the fully assembled state. As can be seen from this Figure, the cam follower pins 122 are located inside the curved cam slots 116. The lever 110 is in an end lock position. As shown in FIG. 3, the bridge 114 may comprise a snap fit connector for securing the lever 110 at the first housing 102 in its end lock position. The state shown in FIG. 3 is the finally mounted stage, as it may be for instance achieved at the end of an automated assembly process. For a manual servicing and disconnecting of the plug connector and the mating connector 104, the lever 110 may manually swiveled around the bearings 108, whereby the cam follower pins 122 are coerced by the swiveling cam slots 116 to loosen the mating connector from the plug connector 102.

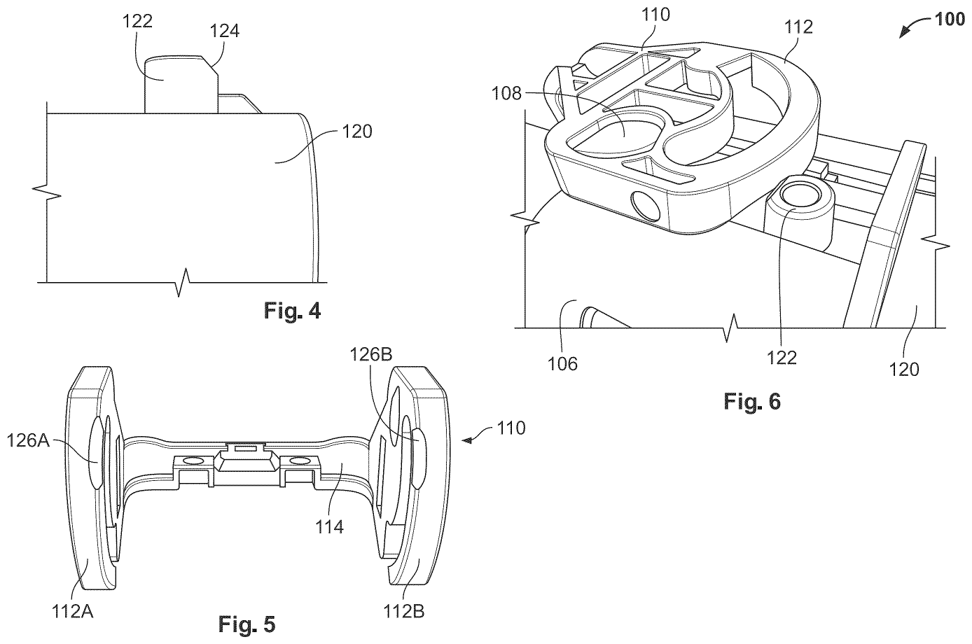

Thus, the connector assembly 100 in this position has the identical functionality as a conventional cam type lever connector assembly. However, as will become apparent from FIGS. 4 to 7, the lever 110 and the cam follower pin 122 also serve the additional functionality of providing a snap fit latching between the plug connector 102 and the mating connector 104. This latching is effected by merely pushing the two parts 102, 104 of the connector assembly 100 together along a mating direction and without rotating the lever 110.

FIGS. 4 to 6 illustrate details of the latching mechanism. In particular, FIG. 4 shows a side view of the second housing 120 with the cam follower pin 122. According to the present disclosure, the cam follower pin 122 has a chamfered region 124, which facilitates pushing the arm 112 of the lever 110 over the cam follower pin 122 when the plug connector 102 and the mating connector 104 are pushed into each other.

Further, as can be seen from FIG. 5, the lever 110 has slanted entry chamfers 126A, 126B, which are arranged in a peripheral region of the arms 112. With the help of the slanted region 126 and the chamfered region 124 together with the resiliency of the arms 112A, 112B, the arms 112 are spread apart when moving the plug connector towards the mating connector 104 so that the cam follower pin 122 snaps into the cam slot 116 and thus latches the plug connector 102 and the mating connector 104.

This latching function is performed with the lever 110 in the end lock position and without rotating the lever 110. FIG. 6 illustrates the position shortly before the lever 110 is forced to slide over the cam follower pin 122.

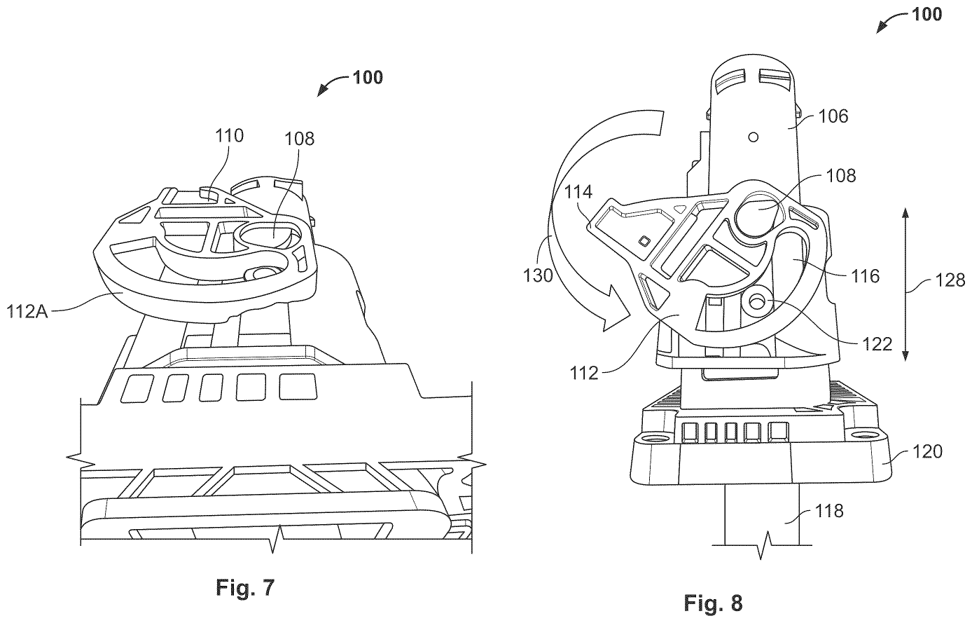

FIG. 7 illustrates the connector assembly 100 in the finally mounted position. The arm 112 has slipped over the cam follower pin 122 which is now resting inside the cam slot 116. Thus, the plug connector 102 and the mating connector 104 are firmly locked together.

For a manual loosening of this connection, the lever 110 can be actuated manually. This step is shown in FIG. 8. As indicated by the arrow 130, an operator may grasp the rotatable lever 110 at bridge 114 and swivel it around the protruding posts 108. The moving cam slot 116 actuates the cam follower pin 122 which in turn leads to a movement of the second housing 120 in a direction opposed to the mating direction. The mating and unmating direction is symbolized in FIG. 8 with the arrow 128. Arrow 130 symbolizes the swivelling motion of the lever 110 for unmating the connector assembly 100.

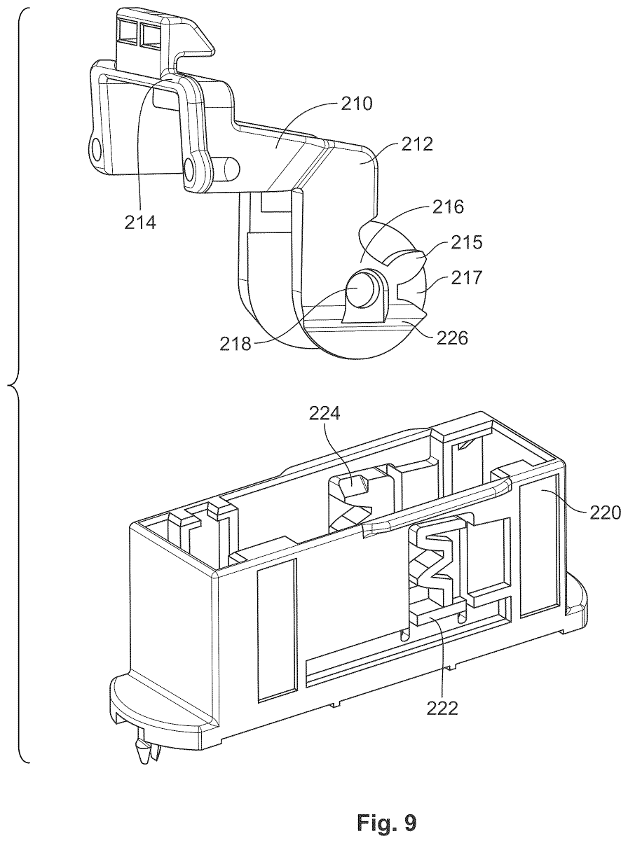

The idea of the double functionality of the lever may not only be used with cam actuated connectors, but also with gear actuated connectors. This second advantageous example will now be explained in detail with reference to FIGS. 9 to 13. According to this example, a plug connector 202 and a mating connector 204 are shown exemplarily as a plug and header.

FIG. 9 illustrates the essential parts of a connector assembly 200 according to the second example, namely the lever 210 and the second housing 220.

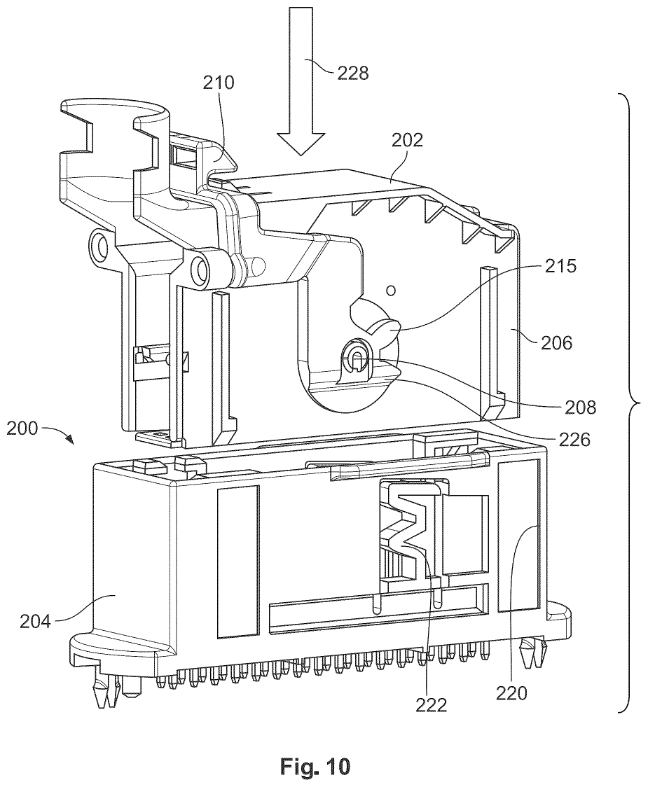

According to the present disclosure, the lever 210 is a gear lever and has a gear element 216 comprising one tooth 215. The lever 210 is for instance a single molded lever mounted on the first housing 206 (see FIG. 10). The lever 210 includes two generally parallel lever arms 212A, 212B joined at one end by a bridge or handle 214. Each lever arm 212 includes a generally circular hub section 217 located at the free ends of the arms and an opening 218 is centrally located within this hub section 217. Each opening 218 is dimensioned to receive a respective post 208 arranged at the first housing 206. Thus, the lever 210 can be mounted on the first housing 206. The tooth 215 extends from the hub section 217.

According to the second example, the second housing 220 comprises deflectable gear racks 222, each one arranged on one side of the second housing 220, which can interact with the gear elements 216. In the following it will be assumed for symmetry reasons that the plug connector 202 has a lever with symmetrical lever arms 212A, 212B with gear elements 216, and the mating connector 204 has corresponding symmetrically formed gear racks 222. However, it is also possible to use the principles of the present disclosure with an asymmetrical design, involving only one lever arm with a gear element and one corresponding gear rack.

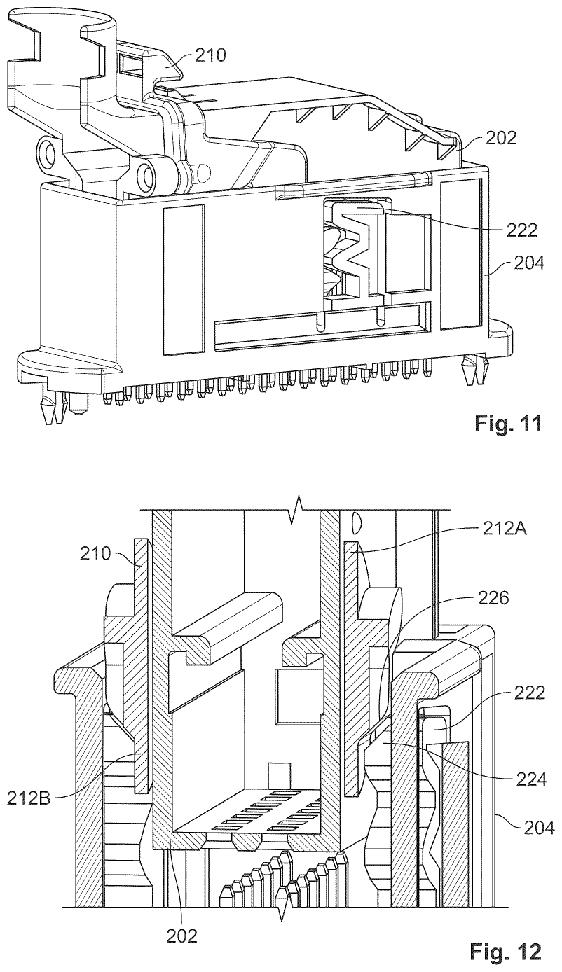

The gear rack 222 firstly forms a rack for actuating the mating connector 204 by rotating the lever 210 as with a conventional gear actuated connector. However, due to the resilient design of the gear rack 222, the plug connector 202 and the mating connector 204 may be assembled automatically with the lever 210 remaining in an end lock position. The hub sections 217 slide past the gear racks 222 and deflect the resilient gear racks 222 outwardly (across the mating direction) until the gear elements 216 and the gear racks 222 snap into locking engagement. Thus, a latching mechanism is provided that secures the plug connector and the mating connector 202, 204 together without the need of rotating the lever 210. The final connected position of the plug connector 202 and the mating connector 204 is depicted in FIG. 11.

The gear rack 222 is additionally provided with a chamfered region 224 to facilitate the latching during the mating of the plug connector and the mating connector 202, 204. The arms 212 of the lever may also be provided with a slanted region 226. As can be seen set from FIG. 12, which illustrates the moment, before the gear elements 216 engage with the gear racks 222, the hub sections 217 are provided with slanted region 226 and the gear rack 22 is provided with a chamfered region 224. Thus, when the plug connector 202 and the mating connector 204 are further pushed towards their final connected position, the gear elements 216 can be slid past the gear racks 222, causing the resilient gear racks 222 to deflect outwardly, across to the mating direction 228.

Once the plug connector 202 and the mating connector 204 are in their final connected position, the gear racks 222 on both sides of the mating connector 204 can engage with the gear elements 216. The gear racks 222 snap back like a snap hook and lock the plug connector 202 and the mating connector 204. For all the steps illustrated in FIGS. 10 to 13, the rotatable lever 210 remains in its end lock position. Thus, for an automated assembly, the actuating function involving the gear element 216 and the gear rack 222 as a transmission is passed over. Instead, the gear rack 222 functions as a snap hook and the gear element 216 functions as the matching snap fit counterpart.

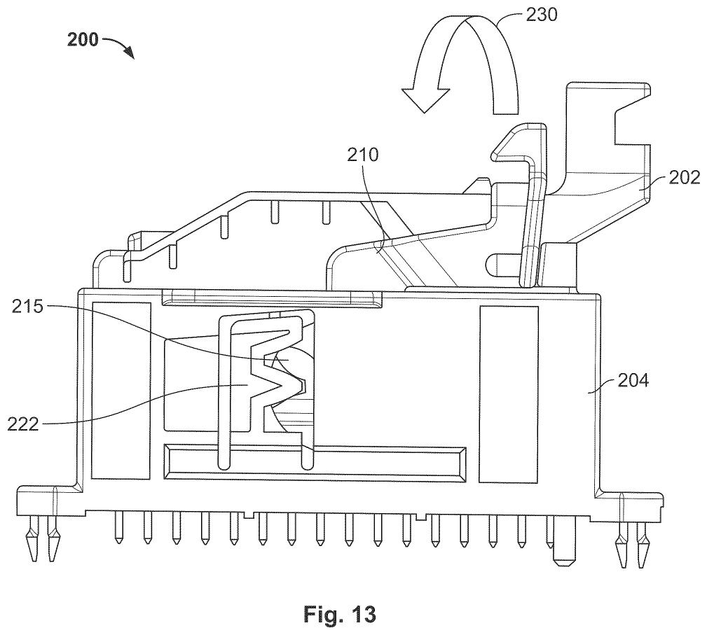

Nevertheless, the lever 210 can still be manually actuated (as indicated by arrow 230 of FIG. 13) in order to un-mate the plug connector 202 from the mating connector 204. Another swivelling motion in the opposite direction can then be used to manually re-connect the plug connector 202 and the mating connector 204.

Thus, the lever 210 and the gear racks 222 have a similar double-function as the lever 110 and cam follower pin 122 of the first example explained above. One of the differences between the two examples is the fact that with the first example, the lever arm is deflected for achieving the snap fit operation, whereas with the second example, the lever arm remains unmoved but the gear racks are deflected.

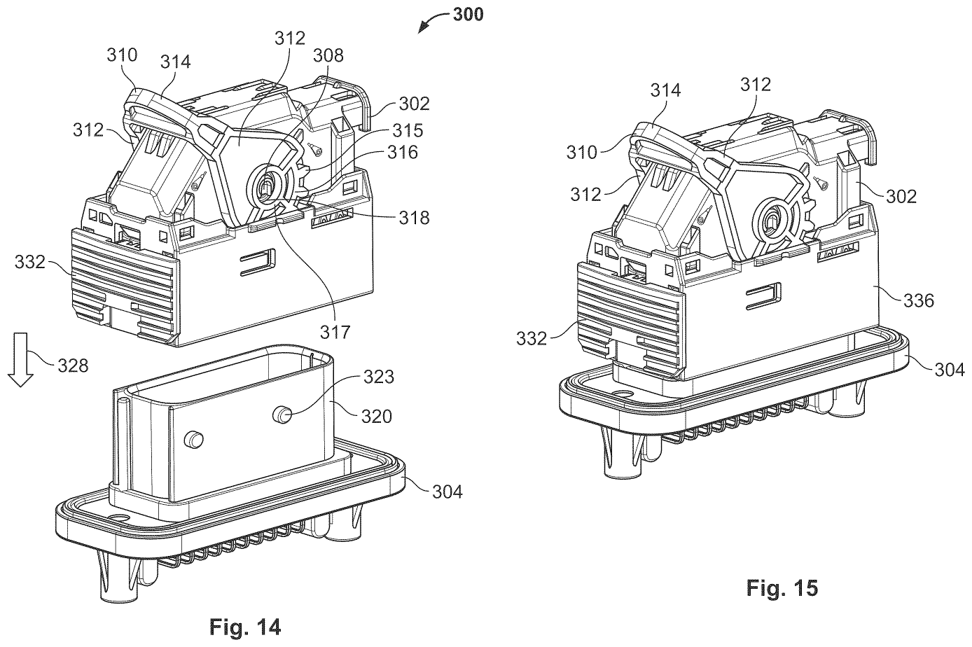

A third example of a connector assembly 300 with a plug connector 302 and a mating connector 304 will be explained referring to FIGS. 14 to 20. While many aspects of the connector assembly 300 according to the third example are similar to those explained above regarding the connector assembly 200 of the second example, an important difference lies in the connector assembly 300 further comprising a locking slider 332 which is displaceable in a direction across the mating/un-mating direction 328.

FIG. 14 shows the connector assembly 300 before the plug connector 302 and the mating connector 304 are mated. The arrow 328 shows the mating direction. As will become more apparent from the following Figures, the second housing 320 comprises a plurality of cam follower pins 323 which also serve for locking the plug connector 302 at the mating connector 304. IN the shown example, four cam follower pins 323 are provided. However, of course, any other suitable number can also be used. Preferably, the cam follower pins 323 are evenly distributed in order to apply forces as symmetrical as possible.

The plug connector 302 comprises a locking slider 332 which can engage with the cam follower pins 323 at the second housing 320. Further, a rotatable lever 310 is provided which has gear elements 316 and is held at the housing 306 of the plug connector 302 similar to the lever shown with respect to the second example. In particular, the lever 310 is a gear lever and has a gear element 316 comprising a plurality of teeth 315. The lever 310 is for instance a single molded lever mounted on the first housing 306. The lever 310 includes two generally parallel lever arms 312 joined at one end by a bridge or handle 314. Each lever arm 312 includes a generally circular hub section 317 located at the free ends of the arms and an opening 318 is centrally located within this hub section 317. Each opening 318 is dimensioned to receive a respective post 308 arranged at the first housing 306. Thus, the lever 310 can be mounted on the first housing 306. The teeth 315 extend from the hub section 317.

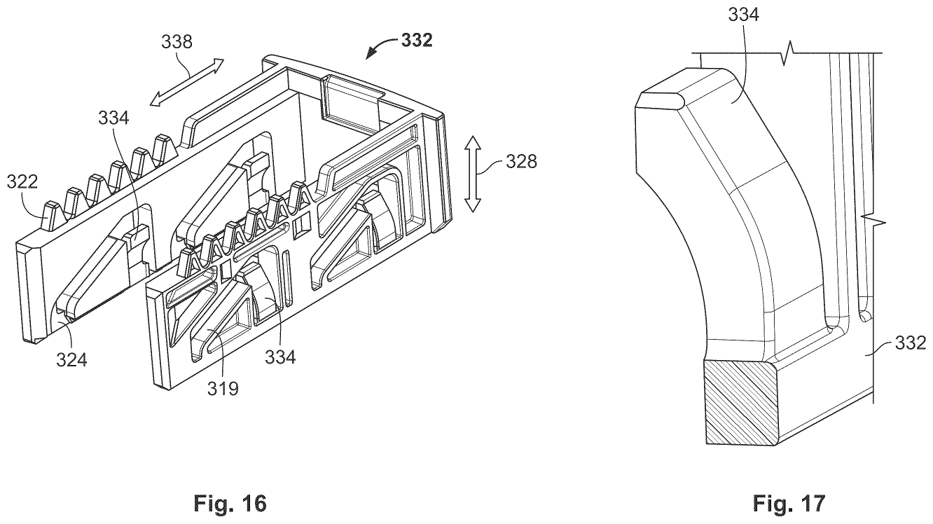

In contrast to the example shown in FIGS. 10 to 13, the gear element 316 interacts with a gear rack 322 which is arranged on the locking slider 332. Thus, moving the rotatable lever 310 causes the locking slider 332 to move in a direction across to the mating direction FIG. 328. As will become apparent from FIG. 16, the movement of the locking slider 332 causes un-mating the connection between the plug connector 302 and the mating connector 304 due to an interaction between the cam follower pins 323 and corresponding cam slots 319 arranged at the locking slider 332.

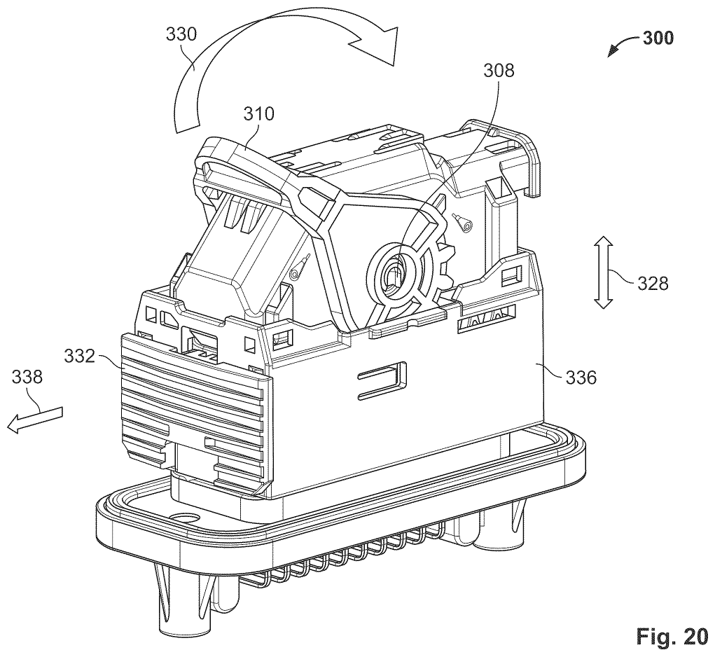

According to the present disclosure, the rotatable lever 310 is in an end lock position as shown in FIGS. 14 and 15. When automatically mating the plug connector 302 and the mating connector 304, the rotatable lever 310 remains inactive and the cam follower pins 323 enter their end lock position inside the cam slots 319 by displacing a resilient snap hook 334 (see FIGS. 16 and 17). Thus, automated mating is facilitated. Nevertheless, the lever 310 can still be manually actuated (as indicated by arrow 330 of FIG. 20) in order to un-mate the plug connector 302 from the mating connector 304. Another swivelling motion in the opposite direction can then be used to manually re-connect the plug connector 302 and the mating connector 304.

Now turning to FIGS. 16 and 17, the locking slider 332 will be described in more detail. The locking slider 332 has a generally U-shaped outline with two arms that can slide in a direction indicated by the arrow 338 within a guide rail housing 336. The guide rail housing 336 is attached to the first housing 306 of the plug connector 302 (see FIGS. 14 and 15).

The locking slider 332 comprises four cam slots 319, each arranged to engage with one of the cam follower pins 323. When the locking slider 332 is moved along the sliding direction 338, the interaction of the cam follower pins 323 with the cam slots 319 translates this movement into a movement along the mating/un-mating direction of the plug connector 302 with respect to the mating connector 304.

For a facilitated actuation of the locking slider 332, the locking slider 332 has a gear rack 322 which can engage with the gear element 316 at the rotatable lever 310. Thus, by swivelling the rotatable lever 310 around the bearing 308, the locking slider 332 can be moved in a translational movement along the direction 338.

The resilient snap hook 334 allows the passing of the cam follower pin 323 by bending the snap hook 334 outwardly, when mating the plug connector 302 and the mating connector 304 automatically. On the other hand, for un-mating the plug connector 302 and the mating connector 304 manually, the cam slots 219 have a chamfered region 324 which allows the cam follower pin 323 to exit the cam slot 319. The chamfered region 324 also allows the cam follower pin 323 to enter the cam slot 319 when manually assembling the plug connector 302 and the mating connector 304.

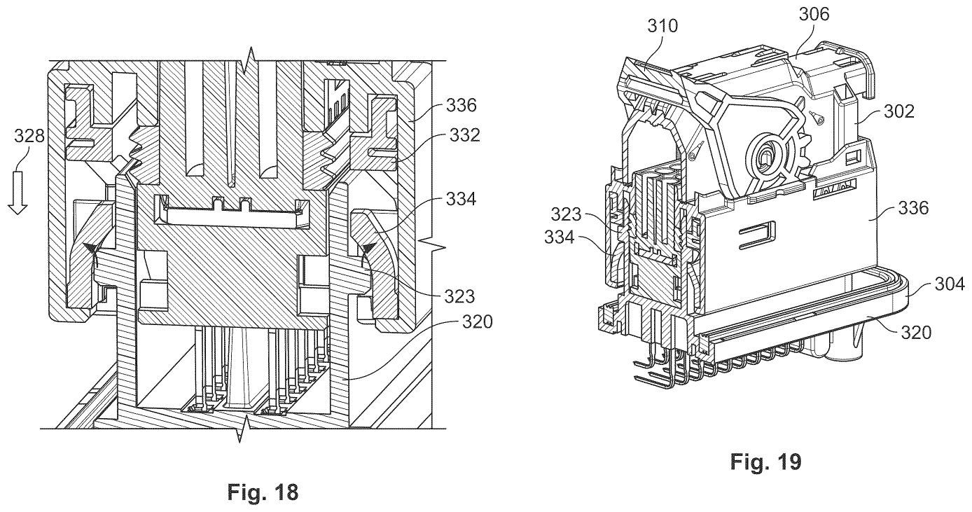

FIGS. 18 and 19 show two sectional views illustrating the step of connecting the plug connector 302 and the mating connector 304, and the mated state, respectively. As can be seen in FIG. 18, the snap hooks 334 are bent outwardly by the cam follower pins 323, when the plug connector is automatically assembled and moved along the direction 328 towards the mating connector 304. In the finally assembled state, which is shown in FIG. 19, the snap hooks 334 have snapped back resiliently, so that the cam follower pins 323 are safely held within the cam slots 319. From this state, a separation of the plug connector 302 and the mating connector 304 can only be achieved by translationally moving the locking slider 332 into an unlocked position (i.e. to the left in FIG. 19). At the same time the interaction of the cam follower pins 323 and the cam slot 319 push apart the plug connector 302 and the mating connector 304 against the mating direction 328.

FIG. 20 illustrates the un-mating process. For moving the locking slider 332 into the unlocked position along the direction 338, the rotatable lever 310 is rotated around its bearing 308 in the direction 330. Thereby, the gear element 316 engages with the gear rack 322 and transforms the rotational movement of the rotatable lever 310 into a sliding movement of the locking slider 332 along the direction 338, which is in turn translated into a separation movement against the mating direction 328 by the interaction of the cam follower pins 323 and the cam slots 319. Thus, the plug connector 302 and the mating connector 304 are separated from each other manually.

When the plug connector 302 and the mating connector 304 have to be manually re-connected, the rotatable lever 310 has to be swivelled upwardly in its unlocked position, so that the locking slider 332 is positioned partly outside the guide rail housing 336. For mating the plug connector 302 and the mating connector 304, the plug connector 302 and the mating connector 304 are aligned with each other and approached so close that the cam follower pins 323 can enter the cam slots 319 via the chamfered region 324. Then, the rotatable lever 310 is rotated into its end lock position, whereby the locking slider 332 is drawing into the guide rail housing 336 and the plug connector 302 and the mating connector 304 are pulled together by the interaction of the cam follower pins 323 and the cam slots 319.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A plug connector for being mated with a mating connector, the plug connector comprising:
a rotatable lever, which is operable to be rotated between an unlocked position and a locked position;
a first housing comprising a pivot bearing for rotatably supporting the rotatable lever;
wherein the lever comprises an actuating element, which is engageable with a driving element arranged at the mating connector, the actuating element being operable to un-mate the plug connector from the mating connector by rotating the lever from the locked position into the unlocked position;
wherein the rotatable lever has latching means, which are operable to lock the plug connector at a corresponding locking element of the mating connector without rotating the lever, when the lever is in the locking position.

2. The plug connector according to claim 1, wherein the lever comprises two resilient lever arms, the lever arms partly encompassing the first housing and being interconnected by a bridge, which is accessible for actuating the lever, and wherein the pivot bearing comprises two shafts, each supporting one lever arm.

3. The plug connector according to claim 1, wherein the lever comprises at least one cam slot forming the actuating element and being engageable with a corresponding cam follower pin arranged at the mating connector.

4. The plug connector according to claim 3, wherein the latching means comprises a slanted peripheral region, which allows a snap fit connection between the cam slot and the cam follower pin when mating the plug connector and the mating connector.

5. The plug connector according to claim 1, wherein the actuating element comprises a gear element, which is engageable with a corresponding gear rack arranged at the mating connector.

6. The plug connector according to claim 5, wherein the latching means comprise a slanted peripheral region, which allows a snap fit connection between the gear element and the gear rack when mating the plug connector and the mating connector.

7. The plug connector according to claim 1, wherein the latching means comprise a snap hook, which is arranged at a locking slider and which is deflectable in a direction across to the mating direction to be slid over a over a cam follower pin arranged at the mating connector, so that the cam follower pin engages with a cam slot arranged at the locking slider.

8. A mating connector for being mated with a plug connector according to claim 1, the mating connector comprising:
a second housing comprising a driving element which is engageable with the actuating element arranged at the rotatable lever of the plug connector, wherein the driving element is operable to un-mate the plug connector from the mating connector by rotating the lever from a locked position into an unlocked position;
wherein the driving element is further formed as a locking element operable to lock the mating connector at the plug connector without rotating the lever, when the lever is in the locking position.

9. The mating connector according to claim 8, wherein the locking element comprises at least one cam follower pin, the cam follower pin having a ramped upper region, which allows the lever to slide over the cam follower pin during the mating operation.

10. The mating connector according to claim 8, wherein the locking element comprises at least one cam follower pin, the cam follower pin being operable to deflect a snap hook so that the snap hook can slide over the cam follower pin during the mating operation.

11. The mating connector according to claim 8, wherein the locking element comprises at least one deflectable gear rack, which allows a gear element of the lever to slide into an engagement with the gear rack during the mating operation.

12. The mating connector according to claim 11, wherein the deflectable gear rack has a chamfered end section to allow the gear element of the lever to slide into engagement with the gear rack during the mating operation.

13. A connector assembly comprising:
a plug connector for being mated with a mating connector, the plug connector comprising:
a rotatable lever, which is operable to be rotated between an unlocked position and a locked position, the lever having an actuating element and latching means;
a first housing comprising a pivot bearing for rotatably supporting the rotatable lever;
the mating connector comprising:
a second housing having a driving element which is engageable with the actuating element arranged at the rotatable lever of the plug connector, the driving element is further formed as a locking element;
wherein the actuating element and the driving element are operable to un-mate the plug connector from the mating connector by rotating the lever from a locked position into an unlocked position;
wherein the latching means are operable to lock the plug connector at the locking element of the mating connector without rotating the lever, when the lever is in the locking position.

14. A method of mating a connector assembly according to claim 13, the method comprising the following steps:
aligning the plug connector and the mating connector, so that they can be mated in a mating direction;
moving the plug connector with respect to the mating connector along the mating direction, until a final mated position is reached;
wherein, during the moving step, the lever is in the locking position and is slid along the mating direction into a latching position, in which the plug connector is locked at a corresponding locking element of the mating connector without rotating the lever.

15. The method according to claim 14, wherein the lever is deflectable and is slid over a cam follower pin arranged at the mating connector, so that the cam follower pin engages with a cam slot arranged at the lever.

16. The method according to claim 14, wherein the mating connector comprises at least one deflectable gear rack, which is deflected in a direction across to the mating direction to allow a gear element of the lever to slide into an engagement with the gear rack.

17. The method according to claim 14, wherein the connector comprises a locking slider, which has a snap hook deflectable in a direction across to the mating direction to be slid over a over a cam follower pin arranged at the mating connector, so that the cam follower pin engages with a cam slot arranged at the locking slider.

18. The method according to claim 14, wherein the lever in the final connected position can be rotated to perform an un-mating of the plug connector and the mating connector.
